(19) United States
(12) Patent Application Publication
(10) Pub. No.: US 2004/0112989 A1
(43) Pub. Date: Jun. 17, 2004

(54) Fluid delivery device having a thermal equilibrating element

(76) Inventor: Andrew Ivan Poutiatine, Menlo Park, CA (US)

Correspondence Address: FACTOR & LAKE, LTD, 1327 W. WASHINGTON BLVD., SUITE 5G/H, CHICAGO, IL, 60607, US

(21) Appl. No.: 10/308,766

(22) Filed: Dec. 3, 2002

(51) Int. Cl. B05B 1/30

(52) U.S. Cl. 239/533.13

(57) ABSTRACT

An implantable fluid-dispensing device having an improved fluid-retainment portion is disclosed as having a housing having a first end and a second end, wherein at least a portion of one of the first end and second end comprises an expandable material, and a thermally activated component associated with the elastic material within the housing wherein the thermally activated component prevents unwanted fluid flow when the housing is exposed to a temperature increase. The thermally activated component can be a shaped single or bimaterial member that expands upon exposure to a temperature increase, or a valve apparatus that halts fluid delivery. Additionally, the entire device can be made from a thermally activated material such that fluid expansion is accommodated. A method for the prevention of the inadvertent release of fluid from a fluid delivery device that is exposed to a temperature increase is also disclosed.

### BACKGROUND OF THE INVENTION

1. Field of the Invention

The present invention is directed generally to fluid delivery devices, and specifically to an improved implantable fluid delivery device.

2. Background of the Art

Fluid delivery devices have been in use for years for a variety of different applications. From delivery of industrial fluids, to everyday fluids such as gasoline, these devices all provide the force and regulation necessary to deliver a specific amount of fluid as needed.

One particularly useful category of fluid delivery devices is implantable fluid-delivery devices for delivering medicament to a patient. Implantable fluid-delivery devices are small, biocompatible pumps that contain a small ampoule or reservoir of medicament, as well as any number of other components to deliver that fluid when needed. The technology contained in these devices can regulate flow rate, delivery time, and whether or not medicament is delivered at all. Once properly implanted, these fluid-delivery devices can deliver pain medication, beneficial medicament, and other necessary fluids according to any number of medical needs.

Essential to these implantable devices is the predictability and consistency of the drug delivery mechanism. Generally, conventional devices have a number of means to regulate the mechanisms that provide the force to deliver the fluid. For example, conventional fluid delivery devices have incorporated gas-generating cells within the devices to generate a gas to drive fluid out of the device. The operational voltage of the gas-generating cell is altered as a function of time in order to deliver different amounts of fluid. Thus, conventionally, fluid-delivery devices have focused on regulating the force-creating mechanism to ensure consistent fluid delivery.

Such conventional devices have been deficient in addressing a significant factor in biological systems that can and does affect fluid delivery rates: body temperature. As body temperatures increase due to factors such as fever, diurnal cycles, environmental changes, or physical activity, the temperature of the fluid within an implanted device is likewise increased. The temperature increase causes, among other things, the fluid contained within the device to expand. Since the implanted devices are small, and must by their nature be sealed devices, the expanded fluid forces its way out of the device in an amount not predicted or desired by the fluid-flow regulation of the delivery mechanism. The force of the expanding fluid can deliver as much as an additional 0.1% of fluid volume per degree Celsius increase. Thus, by ignoring fluctuations in body temperature, the consistency and predictability of fluid delivery in implanted devices can be drastically affected.

It is therefore an object of the present invention to provide an improved implantable drug delivery device that can effectively and efficiently account for temperature increases in surrounding tissues, and that can still deliver a predictable and consistent amount of fluid.

It is additionally an object of the present invention to provide a device that can react to temperature increases within the surrounding environment, and within the device itself, so as to prevent any additional, unwanted drug delivery.

These and other objects will become apparent to one of ordinary skill in the art in light of the present specification, claims and drawings appended hereto.

### SUMMARY OF THE INVENTION

The present invention is directed to a thermally equilibrated fluid delivery device that is capable of delivering consistent fluid delivery rates over an extended period of time as well as a method for the controllable release of a fluid from the device. The device has an improved fluid control means so as to allow for the consistent delivery operation of device, despite variances in environmental conditions such as changes in temperature. As described herein, the device is shown as having a housing with fluid reservoir, a first end, a second end, and one or more delivery holes, with the second end preferably having an expandable portion. The fluid-dispensing device preferably contains a fluid that will be delivered by the device, and which, when exposed to a temperature increase, will expand in size and affect the operation of the device. The device, however, also has a fluid control means, such as a thermally activated component, which enables the device to prevent inconsistent and unwanted fluid flow due to a fluctuation in external temperature. The thermally activated component will prevent any negative influence of the fluid expansion or contraction on the operation of the device by expanding the volume within the device to accommodate the fluctuating fluid size.

In a preferred embodiment of the present invention, the fluid control means includes a thermally activated component associated with a portion of the housing that is expandable. The combination of the component and the expandable portion prevents unwanted fluid flow by increasing the overall volume contained within the housing when it is heated up. The volume is increased by the thermally activated component expanding into the expandable portion to extend that portion outward from the housing and into the surrounding environment.

Preferably, the thermally activated component comprises a material having a coefficient of thermal expansion comparable to the fluid. Alternatively, the thermally activated component could be made up of two or more materials affixed to one another, wherein each of the materials would have a different coefficient of thermal expansion relative to one another, but where the overall thermal expansion coefficient of the component would still be comparable to the fluid. The differences in thermal expansion coefficients between the two affixed materials would allow the thermally activated component to alter its shape in a desired direction once exposed to a temperature increase. If a multi-material component is utilized, the materials may be selected from any of a polymer, a ceramic, a metal, or a combination of those materials. Preferred shapes of the component include a disc, a cantilever, a spiral, a helix, a beam, or a plate.

In the embodiment where the material is in the shape of a disc, it is preferred that the materials have a top sheet and a bottom sheet, and that each sheet is of approximately 4 thousandths of an inch in thickness. Alternatively, additional sheets could be added to the disc, as needed. Preferably, two or more discs are stacked together to form a stack, which multiplies the effects of the expansion of each disc. Stacks could have any number of discs, but preferably would have at least 10 discs to at least 100 discs.

Alternatively, the thermally expandable material can be a single material in, for example, the shape of a beam.

The housing of the device additionally has a delivery hole to allow the flow of the drug from inside the housing to the external environment. In one embodiment, the thermally activated component includes a valve apparatus which, when the component is activated, will come into contact with and close off the delivery hole. Alternatively, the valve could simply begin to curtail the flow of the fluid out of the device, as needed.

In one other preferred embodiment, the fluid control means could be the housing of the device itself. In this embodiment, the housing expands in response to a temperature increase so as to increase the volume within the housing when needed. Preferably, the housing has a thermal expansion coefficient that is at least comparable to the coefficient of the fluid within the housing so that it expands at a rate comparable to the expansion rate of the fluid within the device. The comparison of the two expansion rates does not have to be exact, but could be greater or lesser for the housing than for the fluid, depending upon the desired application.

Any of the above embodiments may be utilized to prevent the unwanted flow of fluid from the device upon exposure of the device to an increase in temperature. The flow may be prevented by increasing the overall volume contained within the housing by the use of a thermally activated component, or by making the housing out of a thermally expandable material. Alternatively, the thermally activated component could include a valve mechanism that would seal off the flow of fluid from the device.

### BRIEF DESCRIPTION OF THE DRAWINGS

FIG. 1 is a plan view of a drug delivery device according to the present invention;

FIG. 1a is a plan view of a drug delivery device according to the present invention;

FIG. 2a shows a perspective view of a single bimaterial disc in a relaxed position as described in the present invention;

FIG. 2b shows a side elevational view of a single bimaterial disc in a relaxed position as described in the present invention;

FIG. 2c shows a side elevational view of a stack of bimaterial discs in relaxed positions as described in the present invention;

FIG. 2d shows a perspective view of a single bimaterial disc in an expanded position as described in the present invention;

FIG. 2e shows a side elevational view of a single bimaterial disc in an expanded position as described in the present invention;

FIG. 2f shows a side elevational view of a stack of bimaterial discs in expanded positions as described in the present invention;

FIG. 3a shows a plan view of a bimaterial cantilever as described in the present invention;

FIG. 3b shows a plan view of a bimaterial simple rod as described in the present invention;

FIG. 3c shows a plan view of a bimaterial unshaped rod as described in the present invention;

FIG. 3d shows a plan view of a bimaterial simple coil as described in the present invention;

FIG. 3e shows a plan view of a bimaterial helix coil as described in the present invention;

FIG. 4 shows a plan view of a drug delivery device according to an alternative embodiment of the present invention;

FIG. 5 shows a plan view of a drug delivery device according to another alternative embodiment of the present invention;

FIG. 6 shows a plan view of a drug delivery device according to another alternative embodiment of the present invention; and

FIG. 7 shows a plan view of a mathematical representation of the area under a disc, as discussed relative to the present invention.

### DETAILED DESCRIPTION OF THE INVENTION

While this invention is susceptible of embodiment in many different forms, there is shown in the drawings, and will be described in detail, several specific embodiments with the understanding that the present disclosure is to be considered as an exemplification of the principles of the invention and is not intended to limit the invention to the embodiments illustrated.

The present invention is shown and described herein as comprising a thermally equilibrated fluid delivery device, and a thermal equilibrator for the device. Generally, the equilibrator is best utilized with fluid-delivery devices implanted in human beings, such as implanted pharmaceutical pumps or the like. It should be noted, however, that the teachings of the present specification and claims may similarly be transferred to any number of external fluid delivery systems in which the device and the fluid within the device undergo expansion due to external thermal changes. For the sake of clarity and consistency throughout the specification and claims, however, the present invention will be discussed in relation to an implantable device. As will be explained in further detail below, any fluid delivery device outfitted with the teachings of the present invention will ensure constant and/or predictable fluid delivery rates, even after sudden temperature increases.

The present invention is best shown in relation to the enclosed drawings. One embodiment of the invention is shown in FIG. 1, which depicts thermally equilibrated delivery device 10 comprising housing 12 containing fluid reservoir 22, delivery mechanism 24, plug 26 and fluid control means 29. Housing 12 is shown as a substantially cylindrical vessel with closed first end 14 and closed second end 16. As would be readily understood to those having ordinary skill in the art, housing 12 may have numerous alternative geometric configurations, such as a disk, cylinder, bellows, sphere, tube, block, etc.—such as would be needed for specific medical applications or implantations.

Housing 12 is preferably constructed from a rigid or semi-rigid biocompatible material such as stainless steel, titanium, other metals, polymers, ceramics, composites, etc. Once constructed, housing 12 provides a secure containment area for medicament and/or other fluids, so that the fluid is maintained in a pristine condition even if the device is implanted into a human body. Additionally, housing 12 provides an enclosure for the delivery apparatus of drug delivery device 10.

First end 14 and second end 16 of housing 12 comprise substantially identically shaped enclosures sealing the inside of housing 12 from the external environment surrounding device 10. First end 14 is associated with delivery mechanism 24, which, as will be described further below, drives fluid from fluid reservoir 22 toward and out of delivery hole 20 located in second end 16 of device 10. In order to help force the fluid out of the device, first end 14 is constructed from a rigid or semi-rigid material, allowing delivery mechanism 24 to operate effectively. Second end 16, on the other hand, includes expandable member 18. An expandable member may comprise any number of conventional devices that expand upon the application of force to the device. It is preferred, in this case, that at least a portion of the structure of second end 16 be constructed from an elastic material such as rubber, called elastic portion 18. Alternatively, expandable member could comprise an accordion shape. In any case, elastic portion 18 is stretched outward by thermally expanded thermal equilibrating member 30 (described further below), which in turn creates a greater volume within housing 12.

As will be explained in greater detail, delivery hole 20 enables release of fluid, from fluid reservoir 22 out of device 10 upon operation of delivery mechanism 24. Generally, delivery hole 20 comprises an opening between interior of housing 12 and the external environmental (e.g. tissue) surrounding device 10. In a preferred embodiment, hole 20 is open continuously, with the pressure difference and flow between the interior of housing 10 and the surrounding bodily tissue through a long and/or tortuous pathway acting as a barrier to the influx of fluids into housing 10. Upon activation of mechanism 24, fluid escapes out of housing 10 through hole 20.

Alternatively, device 10 could have more than one delivery hole 20. It may be necessary to deliver two separate fluids simultaneously, or to deliver a fluid to two different locations in the body, and as such, device 10 may require additional fluid outlets. It is contemplated that the teachings of the present invention may be utilized in conjunction with both the single outlet devices (which will be described herein throughout the specification), and with multiple outlet configurations, as needed.

Contained within housing 10 are the common components of a drug delivery device, including fluid reservoir 22, delivery mechanism 24, and plug 26. Fluid reservoir 22 comprises a containment area for a fluid/medicament to be delivered by device 10. Reservoir 22 may comprise a structure as simple as the interior space of housing 10 located between plug 26 and first end 14, or may comprise any number of conventional fluid-containment vehicles. Preferably, reservoir 22 comprises a fixed-volume polymer-walled section of housing, associated with delivery mechanism 24 on one end, and plug 26 on the other.

Delivery mechanism 24 comprises one of any number of conventional fluid-delivery components, such as compressed gas or propellant, osmotic engine, electromechanical drive, etc. These devices provide a steady motivational force to drive fluid out of reservoir 22, to and through plug 26, and out of hole 20 in second end 16. As is known in the art, the delivery mechanism 24 may also be adjusted via conventional means, such as directly through a surgical procedure, or transdermally through RF reprogramming signals, to alter the specific delivery rate as needed.

Plug 26 is shown in FIG. 1 in its preferred embodiment, having channel 28 running circumferentially in a helical fashion around plug 26 from reservoir 22 to second end 16. Plug 26 separates second end 16 from fluid reservoir 22, and helps to control the delivery rate of fluid out of fluid reservoir 22. Channel 28 consists of a shallow groove connecting fluid reservoir 22 to second end 16, which surrounds plug 26 in a generally spiral shape. Of course, alternative pathways could also be used. The depth and width of channel 28 can be adjusted, as needed, to control the flow rate of fluid out of fluid reservoir 22.

All of the components of device 10, including fluid reservoir 22, delivery mechanism 24, and plug 26 with channel 28, are configured for operation at ideal operational conditions. In other words, under controlled operating conditions, the components deliver a predictable and measured amount of fluid as desired and needed. There are several environmental conditions, however, that can alter the delivery rate, without these standard components changing their operating parameters at all. The present invention is directed towards ensuring that the predictable and measured fluid flow is maintained during the entire operation of device 10, specifically during changes in temperature in the environment surrounding device 10.

In order to achieve a steady and predictable fluid flow, the present device includes fluid control means 29, which is used in association with the previously described components of fluid delivery device 10 to control the flow of thermally-expanded fluid out of device 10. In one preferred embodiment shown in FIG. 1, fluid control means 29 comprises a thermal equilibrating member 30 associated between plug 26 and second end 16 of housing 12. Thermal equilibrating member 30 cooperates with expandable member 18 of housing 12 to, in response to an external temperature change, create additional volume within housing 12 so as to accommodate thermal expansion of the fluid within fluid reservoir 22.

Thermal equilibrating member 30 comprises one or more pieces of material having coefficients of thermal expansion such that member 30 begins to expand upon exposure to a temperature increase. Preferably, thermal equilibrating member 30 comprises a thermal expansion coefficient that is comparable to the fluid contained within fluid reservoir 22, so as to maximize the efficiency of operation of the device. As temperature increases within a body, for example due to fever or sickness, heat from the body is thermally transferred to device 10, and, in turn, into the fluid within fluid reservoir 22. Such a transference of heat results in an increase in the temperature of the fluid within the fluid reservoir 22. Accordingly, this increase in fluid temperature further results in an expansion of the fluid that, in turn, causes unexpected, inconsistent and unwanted release of fluid out of device 10. Similar effects occur upon cooling with the results being a smaller volume of fluid being delivered or no fluid delivery at all.

Thermal equilibrating member 30 accommodates the expanding fluid by likewise expanding in response to a temperature increase. Associated at or near second end 16 of housing 12, thermal equilibrating member 30 expands in a direction toward and into elastic portion 18—thereby forcing elastic portion to deflect outward, which, in turn, results in an increasing in the overall volume within housing 12. This increase in volume is shown in FIG. 1 wherein V1 represents the volume of housing 12 when thermal equilibrating member 30 is in its unexpanded or relaxed state. In this state, thermal equilibrating member 30 does not impact into elastic portion 18 directly. Therefore, housing 12 volume remains static.

As can be seen in FIG. 1a, V2 represents the volume of housing 12 when thermal equilibrating member 30 is in an expanded state. In that state, thermal equilibrating member pushes into elastic portion 18, expanding that part of second end 16 of housing 12 outward. The outward expansion creates additional volume within the housing in order to accommodate the increased volume of the enclosed fluid, so that such fluid is retained within housing 12 until operationally pumped out.

Expansion of thermal equilibrating member 30, and, in turn, expansion of the housing volume is accomplished by fabricating the thermal equilibrating member from certain materials, in certain shapes, as will be described further below. Preferably, the expansion of thermal equilibrating member 30 is caused by either the thermal expansion differences in a bimaterial member, or by thermal expansion of a single-material member in a specific shape.

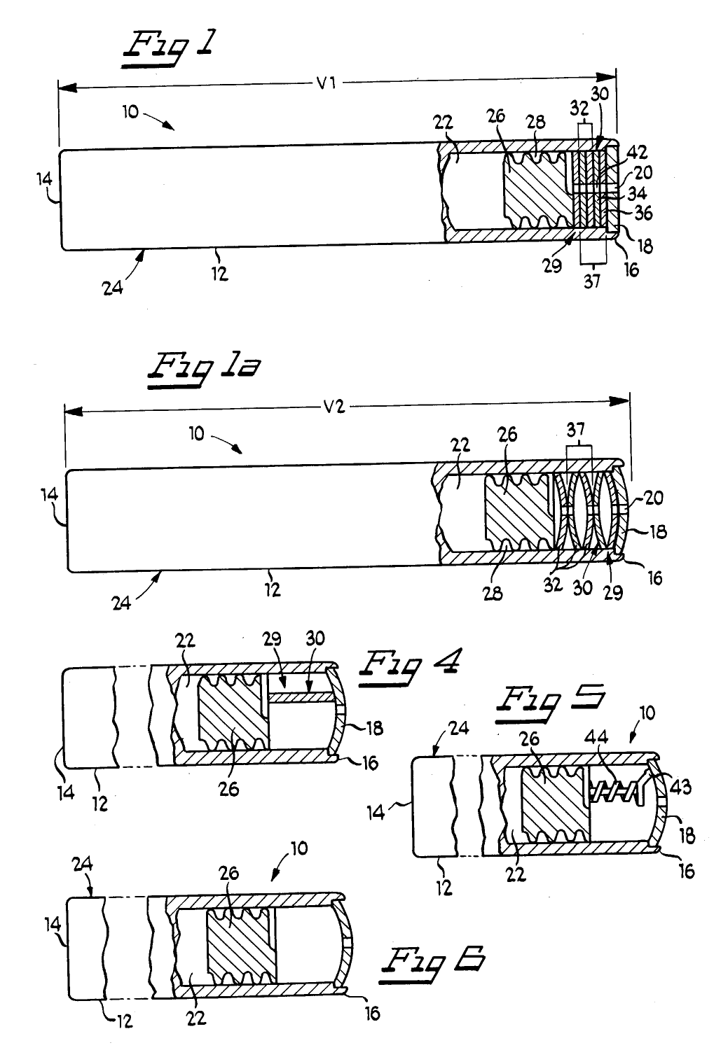

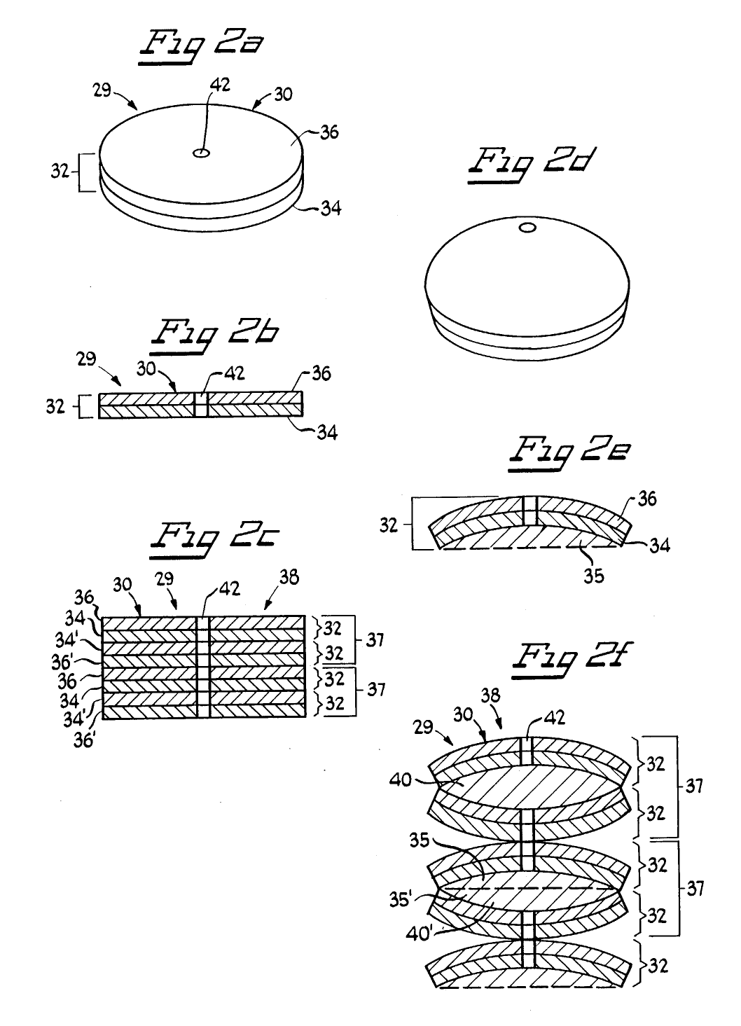

In a preferred embodiment of the present invention, the thermal equilibrating member 30 is fabricated from two materials that are selected for their expansion properties. Specifically, thermal equilibrating member 30 is shown in FIGS. 1-2f as comprising one or more disc shaped members 32. In a preferred embodiment, discs 32 comprise a first material 34 affixed to a second sheet of material 36 to form a substantially planar, circular piece. First material 34 and second material 36 comprise materials having a low and a high coefficients of thermal expansion, respectively, causing second material 36 to thermally expand faster than first material 34 when exposed to a common temperature increase. The difference in expansion between first material 34 and second material 36 causes the shape of the associated discs (shown in FIGS. 2d-2e) to expand from a substantially relaxed configuration (see FIGS. 2a-2c) to an expanded orientation, such as shown in FIGS. 1 and 2d-2f, creating volume 35 underneath. As described above, this expanded orientation causes thermal equilibrating member 30 to deflect into elastic member 18, deflecting the member 18 outward. This deflection, in turn, increases the overall volume within housing 12 from V1 (FIG. 1) to V2 (FIG. 1a).

Importantly, the general shape of the deflection of first material 34 and second material 36, as well as the volume 35 created thereby, material can be accurately predicted using a number of well-known equations, and empirically collected data. Examples of such calculations have been extracted from Roark's Formulas For Stress & Strain (Young, W. C., Roark's Formulas for Stress & Strain pp. 446 (6^{th} Ed., 1989) and are reproduced herein for convenience as Table I.

TABLE I
From Table 24, Case 15

Legend:
Young's Modulus − E
Coeff. Of Thermal Expansion − γ or α
Poisson's Ratio − v
Zero Strain Temp. ≡ Tₒ
$Substitute \frac{6 ( {γ}_{b} - {γ}_{a} ) ( T - {T}_{O} ) ( {t}_{a} + {t}_{b} ) ( 1 + {v}_{e} )}{{t}_{b}^{2} {K}_{1 p}} for the term γ ( 1 + v ) \frac{ΔT}{t}$
${K}_{1 p} ≡ 4 + 6 ( \frac{{t}_{a}}{{t}_{b}} ) + 4 {( \frac{{t}_{a}}{{t}_{b}} )}^{2} + \frac{{E}_{a} {t}_{a}^{3} ( 1 - {v}_{b} )}{{E}_{b} {t}_{b}^{3} ( 1 - {v}_{a} )} + \frac{{E}_{b} {t}_{b} ( 1 - {v}_{a} )}{{E}_{a} {t}_{a} ( 1 - {v}_{b} )}$
Now Replace D with Dₑ
${D}_{e} = \frac{{E}_{a} {t}_{a}^{3}}{12 ( 1 - {v}_{a}^{2} )} {K}_{2 P}$
$Where {K}_{2 p} = 1 + \frac{{E}_{b} {t}_{b}^{3} ( 1 - {v}_{a}^{2} )}{{E}_{a} {t}_{a}^{3} ( 1 - {v}_{b}^{2} )} + \frac{3 ( 1 - {v}_{e}^{2} ) {( 1 + \frac{{t}_{b}}{{t}_{a}} )}^{2} ( 1 + \frac{{E}_{a} {t}_{a}}{{E}_{b} {t}_{b}} )}{{( 1 + \frac{{E}_{at} {t}_{a}}{{E}_{b} {t}_{b}} )}^{2} - {( {v}_{a} + {v}_{b} \frac{{E}_{a} {t}_{a}}{{E}_{b} {t}_{b}} )}^{2}}$
$Replace v with {v}_{e} = {v}_{a} \frac{{K}_{3 p}}{{K}_{2 p}}$
$Where {K}_{3 p} = 1 + \frac{{v}_{b} {E}_{b} {t}_{b}^{3} ( 1 - {v}_{a}^{2} )}{{v}_{a} {E}_{a} {t}_{a}^{3} ( 1 - {v}_{b}^{2} )} + \frac{3 ( 1 - {v}_{e}^{2} ) {( 1 + \frac{{t}_{b}}{{t}_{a}} )}^{2} ( 1 + \frac{{v}_{b} {E}_{a} {t}_{a}}{{v}_{a} {E}_{b} {t}_{b}} )}{{( 1 + \frac{{E}_{at} {t}_{a}}{{E}_{b} {t}_{b}} )}^{2} - {( {v}_{a} + {v}_{b} \frac{{E}_{a} {t}_{a}}{{E}_{b} {t}_{b}} )}^{2}}$
$In Case 15 \text{:} {y}_{c} = \frac{- γΔT}{2 t} [ {a}^{2} - {r}_{0}^{2} - {r}_{0}^{2} ( 1 + v ) ln \frac{a}{{t}_{0}} ]$
If we let r₀ ≡ 0, assuming uniform temperature, then
$\begin{matrix}{y}_{c} = - \frac{{γΔTa}^{2}}{2 t} \frac{( 1 + v )}{( 1 + v )} ⇒ {y}_{c} = - \frac{{a}^{2}}{2 ( 1 + {v}_{c} )} [ \frac{γ ( 1 + v ) ΔT}{t} ] \\ ↖ \\ Replace as above\end{matrix}$

Utilizing these equations, we can calculate the angle of the edge, area under the disc, and volume under the disc, as follows:

$$\begin{matrix}Angle : \frac{Θ}{2} = \frac{a}{( 1 + {v}_{e} )} [ \frac{γ Δ T}{t} ( 1 + v ) ] \\ Area : A = {( \frac{d}{Θ} )}^{2} Cos [ \frac{( \frac{d}{Θ} - y )}{\frac{d}{Θ}} ] - ( \frac{d}{Θ} - y ) \sqrt{2 \frac{d}{Θ} y - {y}^{2}} \\ Volume : V = \frac{1}{3} π {y}^{2} ( \frac{3 d}{Θ} - y )\end{matrix}$$

Wherein theta, y and d determine the system dimensions as shown in FIG. 7

As can be seen, the total deflection of the discs, and the area/volume 35 created under the disc, can be predicted based on the height of the deflection and the angle of deflection, which can in turn be predicted based upon empirically determined constants such as the coefficient of thermal expansion. The constants are accessible from a number of sources, including material handbooks or literature from material suppliers. Some common materials and their constants are listed below.

TABLE II

| | | | COEFF OF | |
|---|---|---|---|---|
| | | | THERM EXP. | |
| | COM- | YOUNG'S | (×10⁻⁶° F.⁻¹) | POISSON'S |
| NAME | POSITION | MODULUS | α | RATIO |
| Ti6Al4V | | 16.5 MPSI | 5.3 | 0.33 |
| Titanium | CP | 15.0 MPSI | 5.3 | 0.33 |
| 316L S.S. | Cr 16-18, | 28 | 8.9 | 0.305? |
| | N: 10-14 | | | |
| | Mo 2-3, | | | |
| Nitinol | 50 N:, T: | | | |
| Aust. | | 12 | 11 | 0.33 |
| Mart. | | 6 | 6.6 | 0.33 |
| Tatalum | | 27 | 3.6 | 0.35 |
| Niobium | | 15 | 4.1 | 0.38 |
| Tungsten | | 59 | 2.5 | 0.28 |
| Zirconium | Zr 702 | 14.4 | 3.2 | 0.34 |
| | Uni Alloy Co. | | | |
| Cobalt | Co35, M: 35, | 33.6 | 8.7 | |
| Alloy | Cr20, Mo10 | | | |
| Gold | 99.5%-100% | 12 | 7.9 | 0.42 |
| Platinum | 99.85% | 25 | 4.9 | 0.39 |
| Silver | | 11 | 10.9 | 0.37 |

GROUP BY α (w/e)

| Low α | High α |
|---|---|
| Tungsten (59) | Nitinol-Aust. (12) |
| Zirconium (14.4) | Silver (11) |
| Tantalium (27) | 316L S.S. (28) |
| Niobium (15) | Cobalt (33.6) |
| Platinum (25) | Gold (12) |
| Titanium (15) | Nitionl-Mart. (6.6) |
| Ti6Al4V (16.5) | |

It should be noted that, preferably, any bimaterial member is comprised of two corresponding materials, with one having a higher thermal expansion coefficient, compared to the other bimaterial. Typically, such materials comprise two metals, such as silver and platinum, or gold and platinum. It is possible, however, to have one or more of the materials comprise a ceramic material or a plastic material. As can be seen from the calculations, the important factors are the difference in thermal expansion coefficients between the two materials, and the similarity in the Young's Modulus. If a combination of materials other than metal/metal is utilized, care should be taken in selecting the bonding agents, as the agent may affect the expansion relationship between the two materials.

In the following sections of this disclosure, certain elements of the present invention have been identified by primes. The primes have been included in the numbering system so as to more clearly define the relationship between identical elements in the drawings. They are not being used to identify elements of the present device having differing properties. For example, as will be discussed below, first material 34 and first material 34′ comprise the same element for purposes of the invention. This convention is continued throughout the specification and the drawings.

Based on the projection of volume increase due to thermal expansion in a bimaterial disc, it is possible to configure a device that is capable of increasing the volume of the device described above as needed. Preferably, and as shown in FIGS. 2c and 2f, thermal equilibrating member 30 comprises two or more discs 32 forming stack 38, wherein the stack comprises alternating pairs 37 of bimaterial discs. Each disc 32 of each pairing 37 comprises a first material 34 and a second material 36. Preferably, discs 32 of each pairing 37 are aligned with the first material 34 of one disc 32 facing the first material 34′ of the next disc 32′.

Upon exposure to a temperature increase, the pairs 37 of discs 32, 32′ will deflect from normal as anticipated by the above equations, forming expanded cavity 40 therebetween. Cavity 40 is formed by the combination of the volume 35 of one disc 32 in a pairing 37, and the volume 35′ of the adjacent disc 32′, upon thermal expansion of each disc 32, 32′. Cavity 40 provides a reservoir for the retention of expanded fluid within housing 12, in addition to providing a means to force thermal equilibrating member 30 into elastic portion 18, pushing it outward to help accommodate the additional volume created by cavity 40.

As will be explained further below, as fluid passes through channel 28 of plug 26, it passes into second end 16 of housing 12, within which discs 32 are located. To accommodate the passage of fluid through discs 32, each disc 32 additionally includes bore 42 passing through both first material 34 and second material 36, providing a fluidic pathway through disc 32. Each bore 42 of each disc 32 is aligned so that when discs 32 are in a relaxed position (FIG. 2c), the bores 42 create a fluid channel through an entire stack 38. Thus, as the fluid enters second end 16 of housing 12, it enters bore 42 for passage through stack 38, and delivery through exit port 20.

In an expanded position (as in FIG. 2f), bore 42 provides access to cavity 40, as well as providing a fluidic pathway through stack 38. Therefore, as fluid enters second end 16, if stack 38 is in a thermally expanded position, fluid will enter stack 38 through bore 42, and accumulate in cavity 40. As the bores 42 will still be substantially aligned, however, fluid will accommodate in one cavity 40 of one pairing 37 until full, and then flow into the next, adjacent cavity 40′. Once all of the cavities 40 of pairings 37 are full, fluid will be delivered out of exit port 20, to the surrounding tissue. Thus, the expansion of thermal equilibrating member 30 accommodates the expansion of fluid out of fluid reservoir 22 by pooling the fluid in cavity 40, without interrupting the normal delivery functions of device 10.

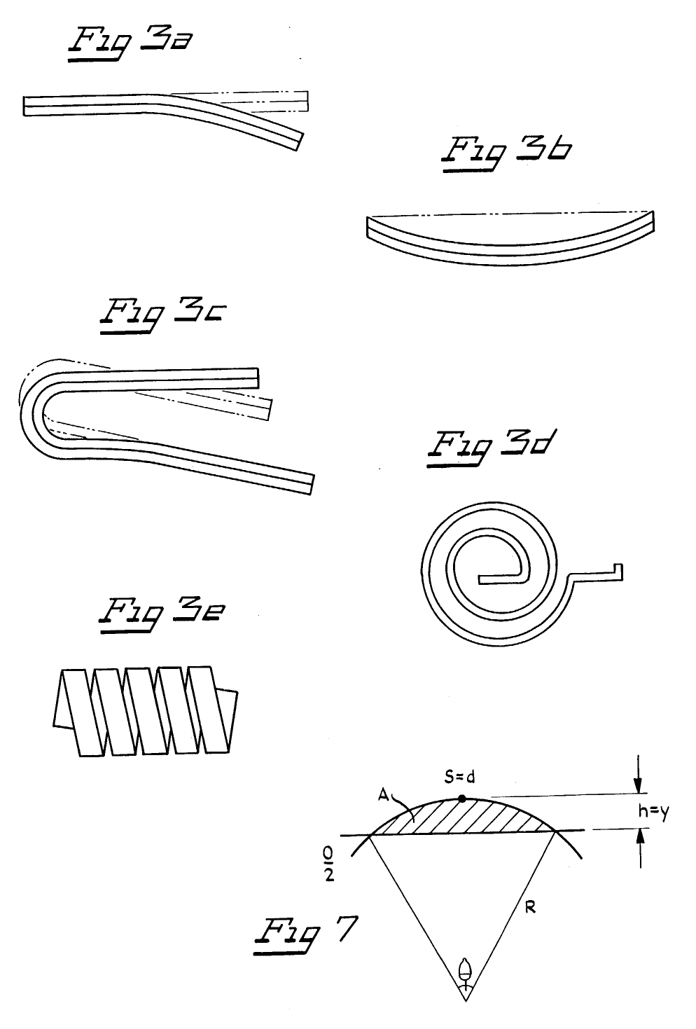

Although the above discussion has been directed to the embodiment of the present invention in which the thermal equilibrator member 30 comprises a disc shape, there are a number of other bimaterial shapes that could similarly provide an increase in volume within the device by thermally expanding into, and stretching outward, the elastic portion 18 of device. For example, and as shown in FIGS. 3a-e, thermal equilibrator member 30 could comprise a cantilever (3a), simple beam (3b), u-shape (3c), coil (3d), or helix coil (3e). Of course, other shapes that provide the same function could also be used, without deviating from the scope of the present invention.

The above embodiments are based on the deflection caused in a piece of material when that material is comprised of two materials having varying coefficients of thermal expansion. This deflection could similarly be achieved through the addition of extra layers, such as a third or a fourth layer. For example, a stack of layers having an increasing coefficient of thermal expansion could be used so that, upon an increase in temperature, a more severe or less severe deflection could be achieved.

In an alternative embodiment, fluid control means 29 comprises a thermal equilibrating member 30 that is formed from a single material. Preferably, the material has a thermal expansion coefficient comparable to the fluid contained within fluid reservoir 22 so as to maximize the efficiency of the operation of the device. In this embodiment, shown in FIG. 4, thermal equilibrator member 30 comprises a single rod-like structure placed between second end 16 of housing and plug 26. As the temperature within the housing is increased, thermal equilibrating member 30 expands stretching elastic portion 18 of second end 16, to, in turn, create additional volume within housing 12.

Each of the above embodiments operates in essentially the same manner. In operation, device 10 is implanted into a subject, such as a human being, with the conventional mechanisms and programming necessary to deliver an amount of fluid contained within fluid reservoir 22 over a set period of time. Under standard conditions, fluid is delivered from fluid reservoir 22 by delivery mechanism 24, driving fluid out of reservoir 22 and into contact with plug 26. Fluid then enters channel 28 of plug 26, wherein the dimensions and path of channel 28, in combination with the force provided by delivery mechanism 24, dictate the rate of fluid flow through plug 26. Fluid exits channel 28, enters second end 16 of housing, and passes through thermal equilibrating member 30, whereafter fluid is delivered to the surrounding environment through delivery hole 20.

After implantation and during normal operation, device 10 may be exposed to a variance in environmental temperature due to, for example, a fever or increased metabolic rate due to physical activity. As the environmental temperature increases, device 10 is heated up, expanding the fluid contained within fluid reservoir 22. At the same time, thermal equilibrating member 30 of device 10 is also heated up, causing thermal equilibrating member 30 to likewise expand. As thermal equilibrating member 30 expands, it makes contact with elastic portion 18 of second end 16, stretching that portion outward and into the surrounding environment—thereby increasing the total volume within housing 12. Due to this increased volume, the additional fluid pushed through plug 26 by the increased volume of fluid is allowed to accumulate in second end 16 of housing 12, without delivering additional fluid to the surrounding environment.

If the elevated environmental temperature is maintained for a period of time, the fluid expansion and the expansion of the thermal equilibrating member 30 will eventually abate, with both the fluid and the thermal equilibrating member 30 reaching an equilibrated, expanded shape. Thermal equilibrating member 30, in its final expanded shape, has created additional volume within housing 12 at or near second end 16, in which the expanded fluid is retained. Delivery mechanism 24, however, continues to operate throughout this process. Although the additional volume created by thermal equilibrating member 30 is intended to encompass the increased volume of the expanded fluid, it is not intended to overcompensate for that volume. To that end, thermal equilibrating member 30 allows for the free flow of fluid there through via, for example, bore 40 or other means for allowing free fluid flow. Therefore, the fluid is continually delivered through delivery hole 20 at the same rate as before thermal expansion, despite the expansion process of the fluid and thermal equilibrating member 30.

Some time after expansion is complete, the temperature of the surrounding environment will eventually cool. For example, either the fever of the patient could break, or the metabolic rates of the body could slow as physical activity decreases. As the environment surrounding device 10 cools, so too will the fluid within device 10, and thermal equilibrating member 30. Due to the sealed nature of reservoir 22, as the fluid cools and contracts in size, a vacuum-like effect is caused within reservoir 22. Fluid that is retained in the expanded volume in first end 14 caused by thermal equilibrating member 30 is pulled back into reservoir 22 instead of being delivered directly through delivery hole 20. The amount of fluid returned into reservoir 22 will be proportional to the temperature decrease, so that normal delivery operation can continue. Additionally, as thermal equilibrating member 30 is cooled, and returns to a relaxed state, the elastic portion 18 will similarly retract so that the expanded volume within second end 16 is also decreased, allowing for efficient operation of device throughout both the heating and cooling processes.

In an alternative embodiment of the present invention, it may be desirous to halt the flow of fluid completely upon exposure to a temperature increase. In such an embodiment, fluid control means 29 comprises a thermal equilibrating member 30 intended to completely halt the flow of fluid out of device 10 upon exposure to a temperature increase. In order to stop the flow of fluid, thermal equilibrating member 30 acts as a fluid valve in this embodiment, actually sealing off delivery hole 20 upon an increase in system temperature. As shown in FIG. 5, thermal equilibrating member 30 can comprise valve 42, which is associated with bimaterial piston 44. As with the structures explained above, piston 44 will undergo a deflection upon an increase in temperature, and the degree of deflection can be predicted based upon temperature increases and known empirical information. The deflection will push piston 44 and valve 20 into contact with exit port 20, sealing off port 20 and therefore fluid flow out of device 20. Exit port 20 can be a portion of a solid housing, with second end 16 of device no longer including the expandable portion 18, or exit port 20 may be associated with an expandable portion 18. Valve 20 should remain in contact with exit port 20, in any case, throughout operation.

Piston 44 is shown in FIG. 5 in one preferred shape as a bimaterial helix, but may additionally comprise any number of shapes, including, but not limited to those shapes specifically highlighted above.

As device 10 of FIG. 5 undergoes a temperature increase due to environmental temperature conditions, piston 44 begins to expand. Upon expansion, piston 44 deflects upward, contacting valve 42 with hole 20. Thereafter, as fluid in reservoir 22 expands, it enters second end 16 of device 10, where elastic portion 18 of second end 16 expands to accommodate the additional volume. Piston 44 continues its expansion throughout the entry of fluid into second end 16, ensuring that valve 42 remains in contact with hole, sealing it. Therefore, no fluid should be delivered from device while the temperature of the surrounding environment is elevated.

Alternatively, thermal equilibrating member 30 could comprise a single disc 32, or stack 38 of discs, wherein the bore 42 therethrough is misaligned with exit port 20. In such an embodiment, a space between discs 32 (in a relaxed position) and exit port 20 enables fluid flow through discs 32 and into the space, and thereafter out of exit port 20. Upon expansion of thermal equilibrating member 30, however, bore 42 would move into contact with elastic portion, and not exit port 20, fluidically sealing bore 42. Thus, flow would be prevented throughout the high temperature operation.

An additional alternative embodiment is shown in FIG. 6, wherein device 10 is shown including housing 12 having first end 14 and second end 16, reservoir 22, delivery mechanism 24 and plug 26. Fluid control means 29 comprises the housing 12 being constructed entirely from a material having a thermal expansion coefficient such that housing 12 begins to expand in response to a temperature increase. Preferably, the thermal expansion coefficient is comparable to the fluid to be enclosed in housing 12. Device 10 does not include thermal equilibrating member 30 in second end 16, however. The material of housing 12 helps device 10 to accommodate the increased volume of fluid in reservoir 22 upon exposure to a temperature increase.

In operation, device 10 of FIG. 6 is implanted into a location such as a human body for the delivery of medicament to the patient. Upon exposure to a temperature increase in the surrounding environment, fluid in reservoir 22 begins to expand. Simultaneously, however, housing 12 begins to expand in an outward direction also, increasing the total volume within housing 12. As the thermal expansion coefficients of housing 12 and the fluid within reservoir 22 are comparable, the expansion of housing 12 should similarly be comparable to the expansion of fluid. Therefore, the increase in fluid volume will be accommodated by the increase in housing 12 volume, ensuring that no additional fluid is forced out of device 10 due to the thermal increase.

The foregoing description merely explains and illustrates the invention and the invention is not limited thereto except insofar as the appended claims are so limited, as those skilled in the art who have the disclosure before them will be able to make modifications without departing from the scope of the invention.

What is claim is:

1. A thermally equilibrated delivery device, comprising:
a housing having a fluid reservoir, a first end, a second end, and at least one delivery hole; and
fluid control means for reducing inadvertent release of fluid out of the at least one delivery hole of the housing in response to an increase in temperature to the housing and, in turn, to fluid within the fluid reservoir.

2. The device according to claim 1, wherein the fluid control means comprises:
an expandable member positioned proximate the at least one delivery hole; and
means for forcing the expandable member to expand outward toward the environment external to the housing upon exposure to the increase in temperature.

3. The device according to claim 2, wherein the forcing means comprises a thermally activated member positioned adjacent the expandable member.

4. The device according to claim 3, wherein the housing includes a fluid therein, and wherein the thermally activated member comprises a material having a coefficient of thermal expansion such that the thermally activated member begins to expand upon exposure to the temperature increase.

5. The device according to claim 3, wherein the thermally activated member comprises at least two materials affixed to one another, the at least two materials comprising materials having different coefficients of thermal expansion relative to each other, wherein the overall coefficient of thermal expansion of the entire member is such that the thermally activated member begins to expand upon exposure to the temperature increase.

6. The device according to claim 5, wherein the at least two materials are in the shape of a disc.

7. The device according to claim 6, wherein the at least two materials comprise at least a top sheet and a bottom sheet, and wherein each sheet is of approximately 4 thousandths of an inch in thickness.

8. The device according to claim 6, wherein the thermally activated member comprises at least two discs, with each disc having at least two materials having different coefficients of thermal expansion.

9. The device according to claim 8, wherein the thermally activated member comprises at least 10 discs.

10. The device according to claim 9, wherein the thermally activated member comprises at least 100 discs.

11. The device according to claim 5, wherein at least one of the at least two materials is selected from the group consisting of ceramics, metals and plastics.

12. The device according to claim 5, wherein the at least two materials are formed in a shape selected from the group consisting of cantilevers, spirals, helixes, beams, and plates.

13. The device according to claim 3, wherein the thermally activated member comprises a single material.

14. The device according to claim 13, wherein the thermally activated member is in the shape of a beam.

15. The device according to claim 1, wherein the expandable member comprises an elastic material, wherein the elastic material comprises a portion of the housing.

16. The device according to claim 1, wherein the expandable member comprises an accordion member, wherein the accordion member comprises a portion of the housing.

17. The device according to claim 1, wherein the fluid control means comprises a thermally activated member associated proximate the at least one delivery hole, wherein the thermally activated member comprises a valve mechanism capable of fluidically sealing the at least one delivery hole upon exposure to the temperature increase.

18. The device according to claim 1, wherein the fluid control means comprises the housing comprising a material having a coefficient of thermal expansion such that the housing begins to expand upon exposure to the temperature increase.

19. A method for preventing the inadvertent release of fluid from an implantable drug delivery device upon exposure of the device to a temperature increase, comprising the steps of:
exposing a drug delivery device to a temperature increase, the drug delivery device comprising a housing having at least one delivery hole in the housing, and an expandable member positioned proximate the at least one delivery hole, wherein the housing, expandable member, and the at least one delivery hole help to define an interior volume, and wherein the interior volume contains a fluid and a thermally activated member;
transferring the temperature increase to the housing and, in turn, to the fluid and the thermally activated member;
expanding the fluid and the thermally activated member located within the housing so as to force the thermally activated member into the expandable member; and
forcing the expandable member to expand outward toward the environment external to the housing so as to increase the internal volume contained within the housing, and thereby preventing any unwanted delivery of the expanded fluid out of the fluid delivery device.

20. A method for preventing the inadvertent release of fluid from an implantable drug delivery device upon exposure of the device to a temperature increase, comprising the steps of:
exposing a drug delivery device to a temperature increase, the drug delivery device comprising a housing having a fluid and a thermally activated member therein, and at least one delivery hole in the housing, wherein the thermally activated member comprises a valve mechanism;
transferring the temperature increase to the housing and, in turn, the fluid and the thermally activated member;
expanding the fluid and the thermally activated member so as to place the valve mechanism into contact with the at least one delivery hole; and
at least partially sealing the at least one delivery hole using the valve mechanism so as to at least diminish the rate of delivery of the expanded fluid from the drug delivery device.

21. A method for preventing the inadvertent release of fluid from an implantable drug delivery device upon exposure of the device to a temperature increase, comprising the steps of:
exposing a drug delivery device to a temperature increase, the drug delivery device comprising a housing having at least one delivery hole in the housing, wherein the housing and the at least one delivery hole help to define an interior volume, and wherein the interior volume contains a fluid;
transferring the temperature increase to the housing and, in turn, to the fluid;
expanding the fluid and the housing so as to increase the interior volume within housing and, in turn, prevent any unwanted delivery of the expanded fluid out of fluid delivery device.
